(19) United States
(12) Patent Application Publication
(10) Pub. No.: US 2015/0348125 A1
(43) Pub. Date: Dec. 3, 2015

(54) CONTENT-DRIVEN ADVERTISING NETWORK PLATFORM

(71) Applicant: Contented Technologies, Inc., Garden City, NY (US)

(72) Inventor: Juergen SCHMIDT, Vienna (AT)

(21) Appl. No.: 14/674,356

(22) Filed: Mar. 31, 2015

Related U.S. Application Data
(60) Provisional application No. 62/004,428, filed on May 29, 2014.

(51) Int. Cl. G06Q 30/02; H04L 29/08

(52) U.S. Cl. CPC G06Q 30/0269; H04L 67/02; H04L 67/10; G06Q 30/0243; G06Q 30/0277

(57) ABSTRACT

A method of automatically selecting a first advertisement for a product according to real time network actions is described. A first content thematically associated with a first advertisement is displayed to a visitor of a third party website. The first content may be free of any explicit reference to a brand or manufacturer of the product. A teaser for the product may be source indistinguishable to the user from other content teasers on the platform. Upon selection of a content teaser, the content is delivered together with the first advertisement. More than one content teaser may be provided for each piece of content and a set of pieces of content may be cycled for the first advertisement. The content teasers and the content pieces displayed may then be optimized based on click through rates.

### CROSS REFERENCE TO RELATED APPLICATIONS

The present non-provisional patent application claims the benefit of priority from U.S. Provisional Patent Application No. 62/004,428, filed May 29, 2014, the entire contents of which are incorporated herein by reference.

### BACKGROUND

1. Field of the Disclosure

The present disclosure relates to targeted advertising and, in particular, to content teaser-based advertising on the Internet.

2. Background of the Disclosure

Internet advertising and Internet sales have seen exponential growth in recent years. The use of cookies to track users and user preferences is well known in the Internet advertising field. For example, when a user uses a browser to visit a website of a vendor, the server of the vendor can cause a cookie to be stored on the user's device and advertising may be provided to the user at a subsequent time based on the cookie. Also well known is tracking a user based on a user search and then providing advertising to the user based on an Internet search conducted by the user.

Thus, according to the known art, an ad server can have various algorithms to determine what ad to present to a particular user. Typically, ad servers track the interests of the user using cookies at the user's device, and provide the most relevant ad to each user based on the cookie.

Teasers for various advertising or sponsor-driven content can be placed on pages rendered by web platforms that users frequent. For example, a news website may have embedded various types of advertising, including banners, images and “advertiser-sponsored” or “sponsor-provided” content. A problem with such an approach is that it is not targeted to the user's preferences and needs, or if it is, it may be based on information about the user from past shopping or interests of the user. Thus, it is based on historical information about the user that is not necessarily reflective of what products the user is interested in buying or learning more about at the present time. This approach assumes that a particular user has the same interests in products today as he did the last time he conducted a web search or otherwise browsed the web. Thus, tracking user behavior over time assumes that the user has more or less fixed, unchanging or constant preferences, needs and interests, and that the user will be attracted to the same types of goods, services or sites over and over again each time he or she uses a network or surfs the web.

### SUMMARY OF THE DISCLOSURE

A method of automatically selecting a first advertisement for a product according to real time network actions is described, the first advertisement to be provided over a network, such as the world wide web, to a user. Such a method may include:

obtaining a first content in response to a receipt of a request to market the product, wherein the first content includes information about a first topic related to the first advertisement;
receiving an association of the first content with the first advertisement;
receiving, by an automated processor, a request for the first content, wherein the request is based on a selection by the user of a first content teaser associated with the first content, and the selection by the user is made from a collection, such as a webpage for example, rendered to the user by a platform on the network; and
selecting, by the automated processor, based on the association, the first advertisement and providing the first content and the first advertisement.

Further aspects of the method are described as follows. In such a method, alone or in combination with any one or more of the further aspects of the invention, such a method may include:

receiving the first advertisement; and
creating the first content before the receiving of the association of the first content with the first advertisement.

In such a method, alone or in combination with any one or more of the further aspects of the invention, the first content may have a thematic relationship to the first advertisement and/or an emotional impact relationship to the first advertisement.

In such a method, alone or in combination with any one or more of the further aspects of the invention, the first content teaser may be linked to the first content via a URL; such a URL may be associated with the platform on the network; the automated processor may be part of a server communicating over the network with the platform on the network.

Such a method may alone or in combination with any one or more of the further aspects of the invention, further include after the selection of the first advertisement, providing the first content to the platform on the network.

Such a method may alone or in combination with any one or more of the further aspects of the invention, further include providing a second content teaser to the user, the second content teaser being source indistinguishable to the user from other items of the collection rendered to the user by the platform on the network; this second content teaser may be provided after the steps recited in the preceding paragraphs; this second content teaser may link to the first content; the second content teaser may link to a second content different from the first content, the first content and the second content both associated with the first advertisement.

In such a method, alone or in combination with any one or more of the further aspects of the invention, the content may include a written composition and/or a video; the first content may be created before the time of the receipt of the request to market the product or may be obtained or generated in response thereto; the first content may be free of any explicit reference to a brand or manufacturer of the product and/or all the information in the first content may be free of being slanted in favor of the product.

In such a method, alone or in combination with any one or more of the further aspects of the invention, a user profile for the user may be stored based on the selection of the first content teaser.

In such a method, alone or in combination with any one or more of the further aspects of the invention, the product may be a good or a service.

Such a method, alone or in combination with any one or more of the further aspects of the invention, may further include:

tracking a number of user selections of the request for the first content based on user selection of the first content teaser;
tracking a number of user selections of the request for the first content based on user selection of a second content teaser;
determining an effectiveness of the first content teaser compared with the second content teaser; and
increasing a number of times a more effective teaser of the content teasers is caused to be displayed relative to a less effective teaser of the content teasers.

Such a method, alone or in combination with any one or more of the further aspects of the invention, may further include:

determining an advertisement click through rate in response to displaying the first content;
determining an advertisement click through rate in response to displaying of a second content, wherein the second content is associated with the first advertisement;
determining an effectiveness of the first content compared with an effectiveness of the second content; and
increasing a number of times a more effective content is caused to be displayed relative to a less effective content.

### BRIEF DESCRIPTION OF THE FIGURES

FIG. 1 illustrates an example of an ad and content engine in relation to various other components communicating over a network, according to an aspect of the present disclosure.

FIG. 2A-B illustrates an example of a communication interaction diagram, according to an aspect of the present disclosure.

FIG. 3A-C illustrates an example of a flowchart of an operation of the ad and content engine, according to an aspect of the present disclosure.

Other features and advantages of the present invention will become apparent from the following description of the invention which refers to the accompanying drawings.

### DESCRIPTION OF THE DISCLOSURE

A user visits a web platform, such as a web server of a news outlet where the user sees “teasers” for content that are supplied by ad and content engine 40. The URL of the teaser may be indistinguishable to the user from other rendered content as to the source of the content. That is, the content teaser may have a URL that is associated with the partner platform 22. For example, partner platform 22 may be a major newspaper provided by a computer server and the content teaser may look like a teaser or link to an article provided by the newspaper. The URL of the article may also look like URLs of newspaper articles on the newspaper's website.

If the content teaser is selected, for example, if it is clicked on or otherwise chosen by the user, that request for the content is forwarded by partner platform 22 to ad and content server 30. The content is then provided to the user together with advertising related to information and topics discussed by the content. A piece of content may be informative text for consumption by the user. The content can be a news article, a guide for a tutorial on a specific topic, an informative essay or composition by an expert or by a journalist about a particular topic, or the like. The content may include an advertorial. The content can also include one or more pictures, video information, music, narration or other audio information or a combination of the foregoing. The company managing ad server 30 can commission or request employees or third-party personnel to write or otherwise generate or find content that is relevant to the advertising that the company wishes to push or provide to users. For example, the company running the ad server may have an account with a vendor that is interested in selling a particular brand of tennis racquets. The company can then commission the writing or the finding and licensing of content that is relevant to tennis racquets. For example, the content may be a factual, objective and sponsor-neutral guide to beginners on how to select a tennis racquet for their level.

A set of such pieces of content may be generated and associated with the advertisement or the ad campaign. For example, 5-7 pieces of content may be provided for a topic, an advertisement or an ad campaign. Teasers for such content can be cycled randomly and rendered to users.

Optimization of content teasers is also contemplated, such that content teasers that fail to generate a sufficient number of quick throughs are eliminated and/or content teasers that generate greater than average number of quick throughs or the most quick throughs are provided more frequently or provided exclusively while underperforming content teasers are eliminated. Thus, a content teaser can work well but the quick through rate for the ad displayed with the content may be poor. For example, the teaser may be too remote conceptually from the content, or may be too remote conceptually from the advertising or from the product being sold. For example, a picture provided in the teaser may attract a user's eyes but may be too removed or not sufficiently tied with the content, or with the advertising provided with the content, to generate sufficient click throughs.

Similarly, content pieces can also be optimized. Content pieces of a set of content pieces associated with an advertisement that do not work sufficiently well, meaning content pieces for which there is a low quick through rate, or content pieces to which users do not respond well, that is, content that is read by users but which does not generate a sufficient percentage of advertisement click throughs, can also be eliminated. Content pieces that generate click throughs to the advertisement can be cycled more frequently or can be cycled exclusively. Thus, testing of what content teasers and what content work to generate click throughs for advertising may be automatically provided and effective content teasers and effective content can be promoted and rendered. Further content teasers and content pieces may be fine-tuned based on trends determined according to click throughs.

The ad and content server 30 may be a computer or a group of computers provided on a network, such as on the worldwide web and may include memory provided as RAM or ROM integrated therewith or provided as separate storage. Similarly, partner platform 22 may be a computer server provided on a network, such as the Internet, and may provide a range of information and content as well as advertising unrelated to the related to the advertising and content provided by ad and content server 30.

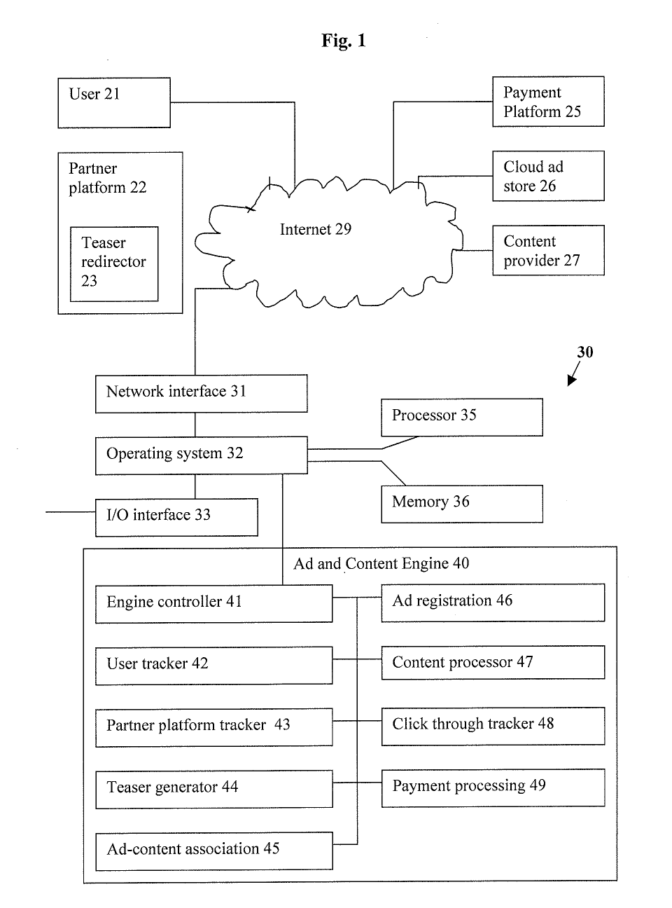

FIG. 1 illustrates user 21 communicating via Internet 29 with partner platform 22, which may include teaser redirector 23. Ad and content server 30 includes network interface 31, and operating system 32 that controls the various components of ad and content server 30. An input/output interface 33 interacts with a user, such as an administrator, who controls or maintains ad and content server 30. Ad and content server 30 also includes processor 35 and memory 36.

Ad and content server 30 also includes ad and content engine 40. With further reference to FIG. 1, engine controller 41 of ad and content engine 40 controls the various components of ad and content engine 40. User tracker 42 tracks the content teasers on which a particular user has clicked or has otherwise selected, and thus “knows” what content and what advertising to return to that user via partner platform 22. Partner platform tracker 43 allows a partner, such as a news outlet, a vendor, a social media server or the like to host content teasers and advertising according to an agreement with a company running ad and content server 30. Ad-content association 45 maintains an association between one or more ads and one or more pieces of content. Such an association may be set by an administrator when uploading content to ad and content engine 40 or may be established automatically by word search and analysis of the content using appropriate known software. Teaser generator 44 can create a teaser, such as a headline, with a URL associated with partner platform 22 that links or is tracked to a piece of content. Alternatively, content teaser and its URL can be generated by Partner Server 22. Ad registration 46 allows ads to be registered to the ad and content engine 40 by various sponsors.

Content processor 47 receives content from content provider 27. For example, content provider 27 may be a journalist or an expert or some third party that is tasked with writing an expert article, a featured story, or educational piece that describes or provides advice on a topic. For example, the topic may be how to improve your tennis game and the content may be an essay written by a prominent athlete or coach about how to select a tennis racquet for your level. Click through tracker 48 monitors the ads associated with content provided by ad and content engine and that are clicked on or otherwise selected by user 21. Payment processing 49 handles payments to partner platforms 22 for hosting content teasers and advertising, and can also receive payments from advertisers for pushing advertising via partner platforms 22. Also, payment processing 49 can keep track of payments to companies or people who provide or write content as needed for the ads.

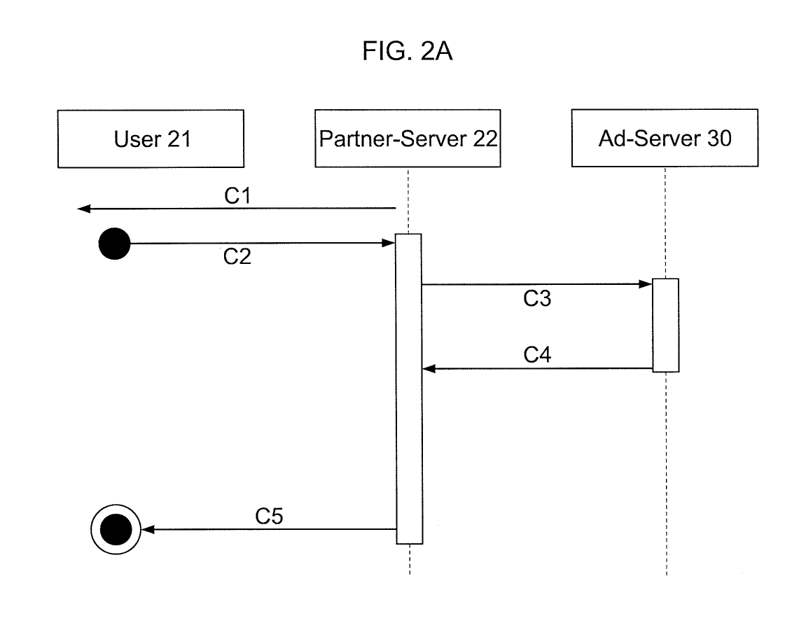

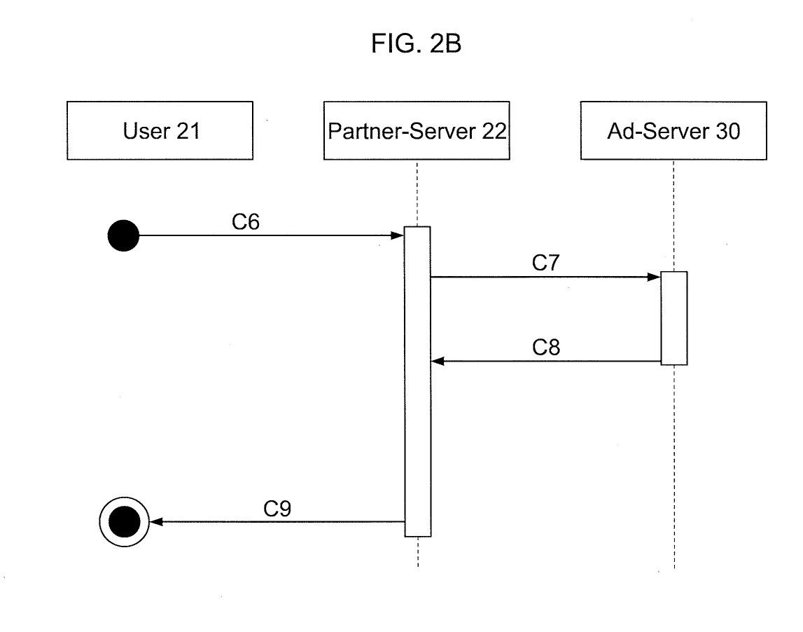

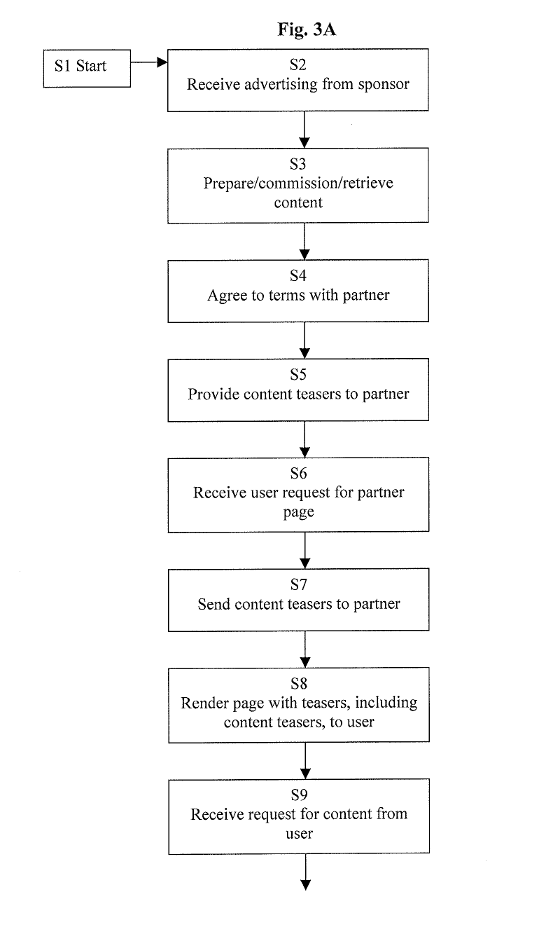

A communication sequence will now be described with reference to FIG. 2. The communication may use HTTP or other protocols. At C1, user is rendered a page by partner server 22. For example, partner server 22 may be a major news outlet or news source that renders a page of teasers to user 21. For example, C1 may be a rendered page using HTML provided to the user that includes a header and a footer provided by the partner server. The rendered page can also include a javascript source tag that can provide the content teaser.

The teasers, when selected, link to articles or images provided as content by partner server 22. Included together with the rendered teasers, for example, headlines, ledes, titles of articles, bylines, photographs, figures, video links, or a combination of the foregoing, are content teasers that may be source indistinguishable by the user from other content provided by partner server 22. A content teaser may be, for example, a headline, a lede, a title of an article, a byline, a photograph, a figure, a video link, or a combination of the foregoing. When a content teaser is selected, at C2, a request is sent for the content to partner server 22. In turn, partner server redirector 23 of partner platform 22 illustrated in FIG. 1 sends a request to ad server 30 for the content that the content teaser has identified. Partner server redirector 23 can maintain an association between a piece of content as known to content server 30 and to content ad and teaser and rendered to user.

Ad server 30 now “knows” what topic or topics the user is interested in at the present time. For example, based on the topic of the content, ad server can now provide ads associated with this topic. The ads may be associated with a topic by a topical relation to the topic or by emotional impact association with the topic, or the like. At C4, the content and the advertising associated therewith is provided by ad server 32 to partner server 22. Partner server 22 can then render a page that includes the content and one or more ads that are highly relevant to the user and likely to be timely for the user's purpose for surfing the web at the present time. For example, the content provided with the rendered page or the advertising provided in the rendered page may be a frame, such as an i-frame. Further teasers to related content can also be provided. For example, content teasers relevant to selecting a tennis ball or a tennis shoe may be provided at C5.

At C6, user can request a page that contains further links or teasers of the same site, for example the partner server may be a news outlet that has a page entitled “Local News,” which may be selected by user. Partner server 22 can then request from ad and content server 30 content teasers to be rendered to the user's browser as part of the rendered page together with the partner server's own teasers for content. The request for content teasers is received by the ad server, shown as C7. At C8, ad and content server 30 responds to partner server 22 with a content teaser that is associated with content prepared for and by the company associated with ad and content server 30. The content, in turn, is associated in advance with one or more ads, which may be hosted by ad and content server 30. For example, further content teasers related to the topic of interest can now be provided.

Ad and content server 30 may also retrieve advertising from cloud ad store 26 via network, such as the Internet 29. For example, the advertising rendered to the user or the teaser for the advertising may be stored at cloud ad store 26 and rendered to a user when user clicks or otherwise selects advertising. That is, cloud ad store 26 may be a server that, when requested, provides advertising images, text, video, audio or combination of the foregoing, in response to a user selection of an advertising teaser request received by ad and content server 30, or received by partner server 22 and sent directly from partner server 22 to cloud ad storage 26.

C9 illustrates communication from partner server 22 to the user's browser, the communication communicating, for example, using HTML, a rendered page with embedded teasers of partner server 22 as well as content teasers provided by ad and content server 30. Content teasers may be indistinguishable for the user from other content provided by partner server 22. Also, content provided to the user in response to a selection of a content teaser, may also be source indistinguishable to the user from other content, such as a news article, provided by partner server 22. For example, URLs of teasers rendered to the user on the page may be for webpages of partner server 22, that is, for example, they may have a domain name that is of the partner server 22 domain.

User profile information may be tracked and maintained for users who click on a content teaser, and/or who click on an advertisement, and a list of such users can be generated automatically. A collection of users is valuable because such consumers have demonstrated an interest in a topic and can then be sold to advertisers as a target audience. Or, as part of the advertisement campaign for a product, such a target audience can be tracked and sold. In this way, demand for the product that is advertised can be built up based on an audience of self-selected users interested in the topic.

Also, cookies can be provided to the browsers of users who click on content teasers, and such users can be tracked all over the world wide web. Additional sites visited or browsed by such users can then be tracked and such information can also be collected and sold.

It will be understood that ad and content server 30 may be provided as part of the same computer, computer system or server bank as partner server 22. Also, while referred to as the Internet 29, and to be understood as communicating via TCP/IP or other types of packet-based communication protocols, other types of networks are also contemplated. The link from ad and content server 30 and the other elements illustrated in FIG. 1 may be thought of as any type of data link, including a wired link, such as a T1 line, Ethernet cable, USB cable, coaxial cable, HDMI cable, or the like, or the link may be via a wireless connection, such as via Wi-Fi, Bluetooth or other type of radio wave infrared or other wireless communication channel.

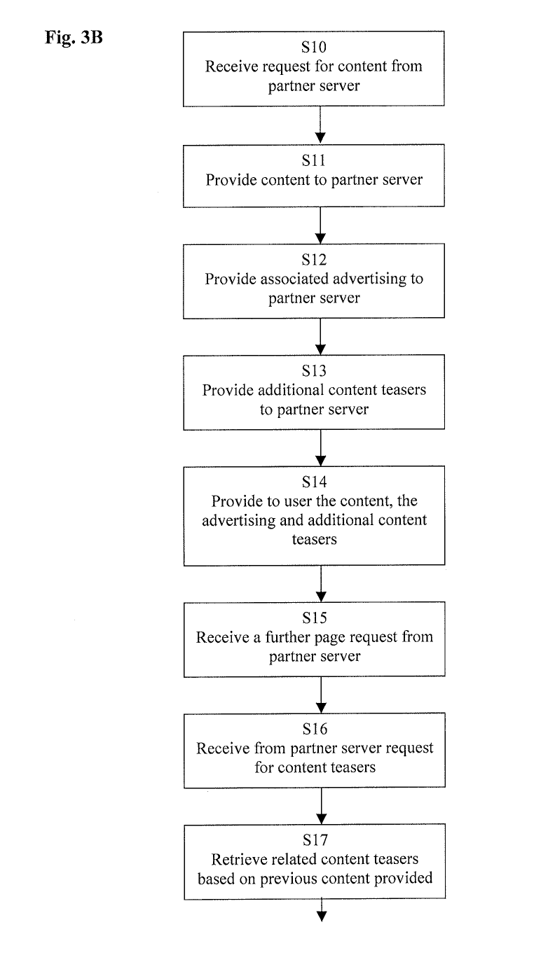

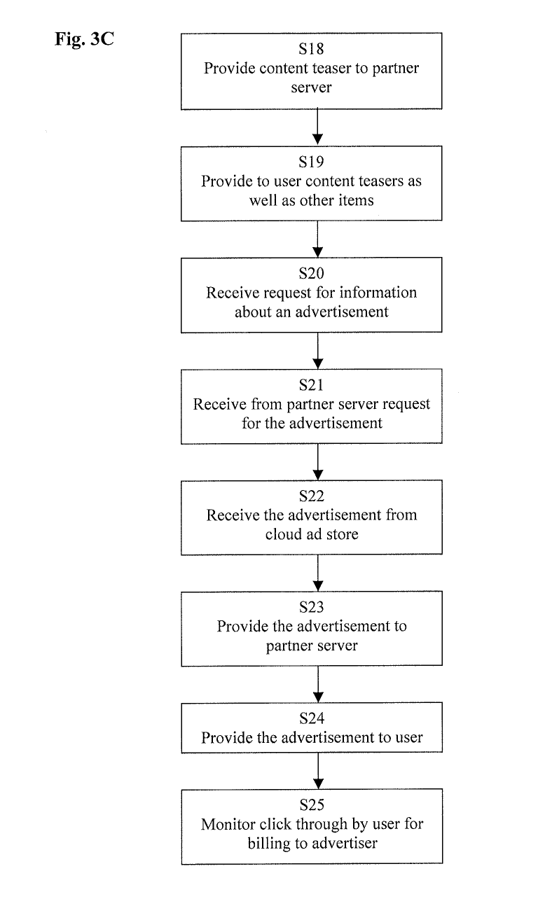

An example of an operation according to the present disclosure will now be described with reference to FIG. 3.

In FIG. 3A after a system start, at S2, an advertising is received from a sponsor. In addition, a product to be promoted may be received from an advertiser and the advertising may also be generated after this stage. Content is prepared, commissioned or retrieved according to the advertising and the product, and the content is associated with the advertising. In addition, content teasers are generated for each piece of content. As discussed above, a set of such pieces of content and respective content teasers for each piece of content may be generated for each advertisement. At S4, a partner with an Internet platform agrees to host content teasers or agrees to render content teasers as part of pages rendered by the partner. At S5, content teasers are provided to the partner platform. At S6, the user visits the partner webpage and at S7 the page is rendered to the user. Content teasers may then be provided to the partner according to the page to be rendered, as illustrated in S7 or, content teasers may be provided in advance to the partner. At S8, the page, including the content teaser is rendered to the user.

At S9, the user selects the content teaser, such as by clicking on a URL, and at S10 in FIG. 3B, the request for the content is received from the partner's server. At S11, the content is provided to the partner server and at S12, advertising associated with the content is also provided to the partner server. Any additional content teasers for the same advertisement or different advertisement may also be provided to the partner server as shown at S13. At S14, the page, with the content teasers and the advertising is provided to the user.

At S15, a further page request is received from the partner server and at S16, an additional request for content teaser is received from the partner server. At S17, additional content teasers are retrieved based on the previous content provided or irrespective of the previous content provided. At S18, additional content teasers are provided to the partner server, and at S19, the additional content teasers as well as the other elements of the page are rendered to the user.

At S20, the user may request information for an advertisement, for example, by clicking on the advertisement teaser. At S21, a request for the advertisement is received from the partner server. The advertisement may be stored as part of the same facility as the ad in content engine 40, or may be provided from an offsite ad server. At S22, the advertisement from the cloud ad store is received and provided at S23 to the partner server. At S24, the advertisement is provided to the user. Click throughs for the content and the frequency of any given content associated with an advertisement may be monitored so as to optimize what content and what content teasers are pushed. In addition, click throughs for advertising can also be monitored and the advertiser can be billed accordingly to the number of click throughs. It will be understood that the process illustrated in FIG. 3 is merely one possible example of the operation of the system, that not all of the steps illustrated in FIG. 3 necessarily need to be performed as part of the invention, and other sequences of the steps, and other combination of steps are also contemplated.

Described herein are a non-transitory computer-readable medium product incorporating a program of instructions, means for, device, and system that provide a method for user-selected content driven advertisements, as described herein. The computer-readable medium may include instruction configured as software, hardware, or firmware, for example, one or more or all of the components of ad and content engine 40 illustrated in FIG. 1, or any component that provides one or more of the functionalities, or any portion of a functionality, described herein . The means for may be any component that provides one or more of the functionalities, or any portion of a functionality, described herein.

A device may be a device that includes or executes such software, hardware or firmware. A computer system may include one or more processors in one or more physical units that includes such a device, or that performs such a method, or that executes the computer-readable medium, according to the present disclosure. Further, these computers or processors, including the content and ad engine or components thereof, may be located in a cloud or offsite or may be provided in local enterprise setting or off premises at a third-party contractor site. One or more component of the device generation engine may be provided as software on a processor-readable medium, such as a hard drive, disk, memory stick, or the like, may be encoded as hardware, or may be provided as part of a system, such as a server computer.

Provided is a technical solution, automatic selection and delivery of advertising based on real time network activity by the user. The content selected according to the interest of the user can then drive in real time the advertising delivered to the user. One of the technical problems that this technical solution solves is that a visitor of a website views random ads or ads customized for the user based on old user profile data, not based on demonstrated current interest.

The content information and the advertising information or other information stored may be stored in a cloud or may be stored locally or remotely. The administrator can interact with ad and content server, for example, set up content-ad associations, order and receive content, upload advertisements and teasers therefore or the like, via a graphical user interface that may include graphics, text and/or other types of information. The ad and content engine may be provided as desktop, laptop computer, handheld device, smartphone and the administrator can interact therewith via various types of data processors, including handheld devices, telephones, mobile telephones, smart phones, tablets or other types of other communication devices and systems.

Various types of memory may be provided in the computer for storing the information, including the content, the advertisements and the like, including random access memory, secondary memory, EPROM, PROM (programmable read-only memory), removable storage units, or a combination of the foregoing. In addition, the communication interface between the major components of the system, or between components of the content and ad server, can include a wired or wireless interface communicating over TCP/IP or via other types of protocols, and may communicate via a wired, cable, fiber optics, line, a telephone line, a cellular link, a satellite link, a radio frequency link, such as a Wi-Fi or Bluetooth, LAN, WAN, VPN, the World Wide Web, the Internet, or other such communication channels or networks or a combination of the foregoing.

While the preferred embodiments of the invention have been illustrated and described, further modifications and adaptations, and other combinations or arrangements of the structures and steps described come within the spirit and scope of the application and the claim scope. Further, one or more features discussed with respect to any aspect or embodiment of the disclosure, including the Drawings, may be combined with or implemented in other aspects or embodiments described herein and such a combination or implementation comes within the subject matter of the invention.

What is claimed is:

1. A method of automatically selecting a first advertisement for a product according to real time network actions, the first advertisement to be provided over a network to a user, the method comprising:
obtaining a first content in response to a receipt of a request to market the product, wherein the first content includes information about a first topic related to the first advertisement;
receiving an association of the first content with the first advertisement;
receiving, by an automated processor, a request for the first content, wherein the request is based on a selection by the user of a first content teaser associated with the first content, and the selection by the user is made from a collection rendered to the user by a platform on the network; and
selecting, by the automated processor, based on the association, the first advertisement and providing the first content and the first advertisement.

2. The method of claim 1, wherein the network is the world wide web, and the platform on the network is an Internet platform.

3. The method of claim 1, further comprising:
receiving the first advertisement; and
creating the first content before the receiving of the association of the first content with the first advertisement.

4. The method of claim 1, wherein the first content has a thematic relationship to the first advertisement.

5. The method of claim 4, wherein the first content has an emotional impact relationship to the first advertisement.

6. The method of claim 1, wherein the first content teaser is linked to the first content via a URL.

7. The method of claim 6, wherein the URL is associated with the platform on the network.

8. The method of claim 1, wherein the automated processor is comprised of a server communicating over the network with the platform on the network.

9. The method of claim 1, further comprising after the selection of the first advertisement, providing the first content to the platform on the network.

10. The method of claim 1, further comprising: providing a second content teaser to the user, the second content teaser being source indistinguishable to the user from other items of the collection rendered to the user by the platform on the network.

11. The method of claim 10, wherein the second content teaser is provided after the steps of claim 1.

12. The method of claim 10, wherein the second content teaser links to the first content.

13. The method of claim 10, wherein the second content teaser links to a second content different from the first content, the first content and the second content both associated with the first advertisement.

14. The method of claim 1, wherein the content comprises a written composition.

15. The method of claim 1, wherein the content comprises a video.

16. The method of claim 1, wherein the collection is a rendered page.

17. The method of claim 1, wherein the first content exists before the time of the receipt of the request to market the product.

18. The method of claim 1, wherein the first content is free of any explicit reference to a brand or manufacturer of the product.

19. The method of claim 1, wherein all the information in the first content is free of being slanted in favor of the product.

20. The method of claim 1, further comprising storing a user profile for the user based on the selection of the first content teaser.

21. The method of claim 1, wherein the product is a service.

22. The method of claim 1, further comprising:
tracking a number of user selections of the request for the first content based on user selection of the first content teaser;
tracking a number of user selections of the request for the first content based on user selection of a second content teaser;
determining an effectiveness of the first content teaser compared with the second content teaser; and
increasing a number of times a more effective teaser of the content teasers is caused to be displayed relative to a less effective teaser of the content teasers.

23. The method of claim 1, further comprising:
determining an advertisement click through rate in response to displaying the first content;
determining an advertisement click through rate in response to displaying of a second content, wherein the second content is associated with the first advertisement;
determining an effectiveness of the first content compared with an effectiveness of the second content; and
increasing a number of times a more effective content is caused to be displayed relative to a less effective content.
